(19) United States
(12) Patent Application Publication
(10) Pub. No.: US 2005/0269344 A1
(43) Pub. Date: Dec. 8, 2005

(54) Dispensing cover and substrate dispenser

(76) Inventors: Gary Fabian Madsen, Greenville, WI (US); Chatchawan Man-In, Pathumthani (TH); Cynthia Watts Henderson, Neenah, WI (US); Michael William Smaby, Neenah, WI (US); Daphne Lynn VanBuren, Greenville, WI (US); Sara Marie Vermillion, Menasha, WI (US)

Correspondence Address: KIMBERLY-CLARK WORLDWIDE, INC., 401 NORTH LAKE STREET, NEENAH, WI, 54956, US

(21) Appl. No.: 10/862,603

(22) Filed: Jun. 7, 2004

(51) Int. Cl. B65G 59/00; G07F 11/16; B65H 1/00; B65H 3/00

(52) U.S. Cl. 221/63

(57) ABSTRACT

A dispensing cover for use with a container to form a dispenser for substrates has a minimum thickness for the material forming the perimeter of the dispensing opening to reduce the dispensing drag and/or dispensing noise. In one embodiment, the dispensing cover can comprise a dispensing lid that is snapped over the open end of a cup that is filled with a stack of facial tissues. In another embodiment, the dispensing cover can comprise a dispensing plug that is inserted into one end of a hollow tube that is filled with a stack of facial tissues and closed on the opposing end with a bottom plug.

### BACKGROUND

Facial tissue dispensers frequently comprise a carton made from paperboard that has a dispensing opening. Often located within or adjacent to the dispensing opening is a dispensing window comprising a flexible film material and having a dispensing slit. One of the functions of the dispensing window is to hold a partially dispensed sheet within the dispensing opening ready for use by a person. Another function is to smoothly and reliably assist in guiding the facial tissue sheet from the carton's interior through the opening such that the dispensing opening does not grab the facial tissue possibly leading to a dispensing failure, such as ripping the tissue as it is dispensed. Carton-style facial tissue dispensers are commercially successful as evidenced by their ubiquitous use.

Recently, new dispensers for substrates, such as wet wipes, facial tissue, nonwovens and the like, have been designed for enhanced portability. Often these newer dispensers utilize materials having more crush resistance than paperboard such as plastic materials. These dispensers can be designed for placement within automobile cup holders if desired by the selection of appropriate geometry for the dispenser. Integrating a standard film dispensing window into such dispensers can be difficult, cost prohibitive, or require manual assembly steps. Therefore, what is needed is a dispenser for substrates, especially dry substrates such as facial tissue, that dispenses smoothly without grabbing the substrate and with a high degree of reliability and eliminates the need to use a film dispensing window.

### SUMMARY

A dispensing cover for use with a container to form a dispenser for substrates has a minimum thickness for the material forming the perimeter of the dispensing opening to reduce the dispensing drag and/or dispensing noise. In one embodiment, the dispensing cover can comprise a dispensing lid that is snapped over the open end of a cup that is filled with facial tissues. In another embodiment, the dispensing cover can comprise a dispensing plug that is inserted into one end of a hollow tube that is filled with facial tissues and closed on the opposing end with a bottom plug.

In another embodiment, the invention resides in a product comprising: a container and a dispensing cover having a top panel and a dispensing opening located in the top panel; the dispensing cover attached to the container to form a dispenser; a dry substrate located within the dispenser; and wherein a thickness of the top panel forming a perimeter of the dispensing opening is between about 0.040 inch (1 mm) to about 0.25 inch (6.4 mm).

In another embodiment, the invention resides in a product comprising: a dispensing cover having a top panel and a vertical flange extending from the top panel; the vertical flange has a depth that is less than about 45 mm; a dispensing opening located in the top panel; and wherein a thickness of the top panel forming a perimeter of the dispensing opening is between about 0.040 inch (1 mm) to about 0.25 inch (6.4 mm) and the area of the dispensing opening is between about 600 mm² to about 2,500 mm².

### BRIEF DESCRIPTION OF THE DRAWINGS

The above aspects and other features, aspects, and advantages of the present invention will become better understood with regard to the following description, appended claims, and accompanying drawings in which:

FIG. 1 illustrates one embodiment of a dispenser for substrates.

FIG. 2A illustrates a dispensing lid for the dispenser of FIG. 1.

FIG. 2B illustrates a cross-section taken at line 2B-2B of FIG. 2A.

FIG. 2C illustrates a cross-section taken at circle C of FIG. 2B.

FIGS. 3A, 3B, 3C, 3D, 3E, 3F, 3G, 3H, and 3I illustrate cross-sections for different embodiments of the perimeter of the dispensing opening.

FIG. 4 illustrates another embodiment of a dispenser for substrates.

FIG. 5A illustrates a top view of a dispensing plug for the dispenser of FIG. 4.

FIG. 5B illustrates a side view of the dispensing plug of FIG. 5A.

FIG. 5C illustrates a cross-section of the dispensing plug taken at line 5C-5C.

FIG. 6 illustrates a graph of dispensing noise level for various dispensers.

FIG. 7 illustrates a graph of dispensing force for various dispensers.

Repeated use of reference characters in the specification and drawings is intended to represent the same or analogous features or elements of the invention.

### Definitions

As used herein, forms of the words “comprise”, “have”, and “include” are legally equivalent and open-ended. Therefore, additional non-recited elements, functions, steps or limitations may be present in addition to the recited elements, functions, steps, or limitations.

As used herein, “substrate” is a flexible sheet or web material, which is useful for household chores, personal care, health care, food wrapping, and cosmetic application or removal. Non-limiting examples of suitable substrates of the present invention include nonwoven substrates, woven substrates, hydro-entangled substrates, air-entangled substrates, paper substrates comprising cellulose such as tissue or paper towels, waxed paper substrates, coform substrates, wet wipes or moistened substrates, film or plastic substrates such as those used to wrap food, and metal substrates such as aluminum foil. Furthermore, laminated or plied together substrates of two or more layers of any of the preceding substrates are suitable.

As used herein, “dry substrate” is a substrate containing less than about 15 percent by weight of a liquid such as water or alcohol that feels dry to the touch. Suitable dry substrates can include paper substrates such as facial tissue, bath tissue, or paper towels. Further examples of dry substrates include a substantially dry substrate (less than 10 percent by weight of water) containing lathering surfactants and conditioning agents either impregnated into or applied to the substrate such that wetting of the substrate with water prior to use yields a personal cleansing product. Such substrates are disclosed in U.S. Pat. No. 5,980,931 entitled Cleansing Products Having A Substantially Dry Substrate issued to Fowler et al. on Nov. 9, 1999, and herein incorporated by reference in a manner consistent with the present disclosure.

### DETAILED DESCRIPTION

It is to be understood by one of ordinary skill in the art that the present discussion is a description of exemplary embodiments only, and is not intended as limiting the broader aspects of the present invention, which broader aspects are embodied in the exemplary construction.

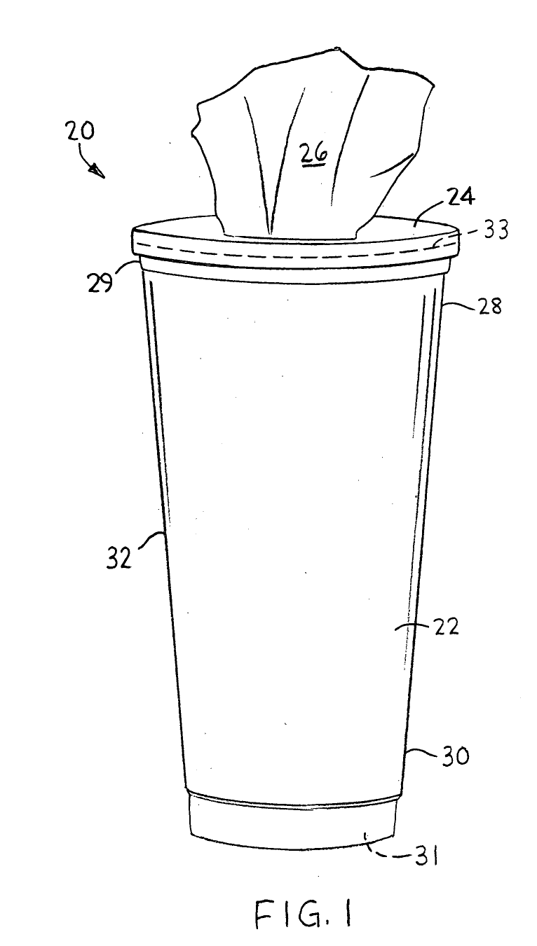

Referring now to FIG. 1, a dispenser 20 for substrates is illustrated. The dispenser includes a container for the substrate such as a cup 22 and a dispensing cover 24. Located within the cup 22 is a plurality of sheets 26 made from a substrate. The sheets can be individual discrete sheets that may be folded or interfolded for pop-up dispensing. Alternatively, the sheets may be integrally connected to each other by lines of weakness such as perforations. The sheets can be either in a stack or rolled configuration. In one embodiment, the sheets comprised a stack of interfolded facial tissues having approximately 50-60 individual discrete sheets for pop-up dispensing where the next sheet is automatically left partially dispensed upon removal of the preceding sheet. In other embodiments, the dispenser can contain more sheets such as 1,000 sheets or less, 500 sheets or less, 300 sheets or less, and 200 sheets or less.

The cup 22 comprises a top portion 28 having an open end 29, a bottom portion 30 having a bottom 31, and a sidewall 32. A flange 33, located near the open end 29, projects from the perimeter of the top portion for securing the dispensing cover 24. The cup can be made from a rigid or semi-rigid material such as a molded plastic material or formed from paperboard or carton material. The sidewall 32 can be straight, tapered, or stepped such that the top portion of the cup is larger than the bottom portion. For use in an automobile cup holder, the bottom portion of the cup should have a maximum width for a sufficient length such that it can be inserted into a cup holder. The maximum width can be less than about 90 mm, such as less than 80 mm. For example, the maximum width can be approximately equal to the 68 mm diameter of a standard 12 oz. beverage can. In one embodiment, the sidewall was a tapered circular body and the diameter of the open end 29 was approximately 90 mm, the diameter of the bottom 31 was approximately 60 mm, and the cup was approximately 172 mm high.

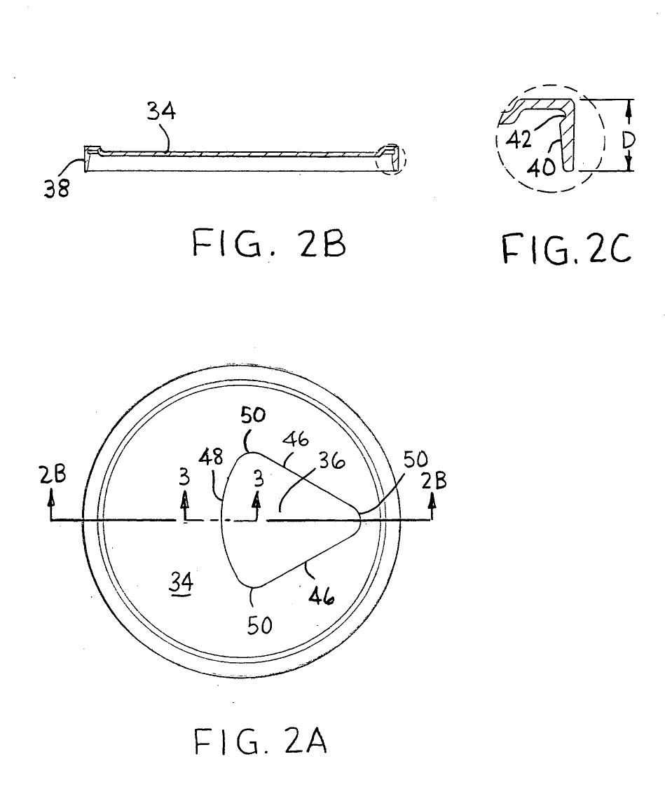

Referring now to FIGS. 2A, 2B, and 2C, the dispensing cover 24 is shown in more detail. In this embodiment, the dispensing cover 24 comprises a dispensing lid that snaps onto or over the open end 29 of the cup 22. The dispensing lid comprises a top panel 34 having a dispensing opening 36 and a vertical flange 38. The dispensing lid is made from a rigid or semi-rigid material, such as molded plastic or paperboard, as opposed to a flexible material such as a thin plastic film.

The vertical flange can have a depth D of between about 45 mm, or about 40 mm, or about 30 mm, or about 20 mm, or about 15 mm, or about 10 mm to about 1 mm, since the dispensing cover is intended to be utilized with a container to form a disposable dispenser. The vertical flange is used to attach the dispensing cover to the open end of the container by either inserting the vertical flange into the container or placing the vertical flange around the container's rim. Other decorative covers for standard facial tissue cartons have a taller side panels such that the cover completely encloses the tissue box on the top and sides. Such covers are intended to be placed over a standard tissue carton and used indefinitely by replacing the facial tissue carton when it is depleted. The vertical flange 38 can have a projection 40 and a recess 42 on the interior of the vertical flange. The projection and the recess engage with the flange 33 on the cup 22 for removably securing the dispensing lid onto the cup.

If desired, a second lid without an opening can be placed over the dispensing lid to close the dispensing opening during shipping. Alternatively, a peel strip, surf board, or shrink wrap film can be placed over the dispensing opening and removably attached to the dispenser. In yet another embodiment, a surf board or removable circular disk can be placed over the top panel of the dispensing lid and then a shrink wrap removable film placed over the dispensing lid and part of the top portion of the cup. The shrink wrap and circular disk is then removed and disposed of prior to removing the first sheet from the dispenser. The removable circular disk can be printed with trademark information or other indicia to indicate the contents of the dispenser. This can free the dispenser's exterior surface for use in creating an aesthetic design uncluttered with printed matter unrelated to the aesthetic design.

For reliable dispensing of the substrate, such as facial tissue, through the dispensing cover 24 without using a film dispensing window, the inventors have determined that several factors should be controlled to reduce the dispensing force (as tested herein later) or to reduce the dispensing noise (as tested herein later). The inventors have determined that when the film dispensing window is removed, an unacceptable dispensing noise or a large dispensing force can occur unless the dispensing opening is properly designed. For one such example, see Comparative Example 1 in the Examples section of this document. Reduction in the dispensing drag force and/or the dispensing noise is believed to be indicative of an enhanced and more reliable dispensing function. The dispensing noise is believed to correlate with the propensity for the substrate to drag and catch on the dispensing opening when removed from the dispenser. Additionally, a high level of dispensing noise can be objectionable to consumers used to dispensing facial tissue through film dispensing windows. The noise can be perceived as being caused by a lower quality facial tissue that is scratchy and/or stiff, having reduced softness since the tissue tends to catch on the dispensing opening when in fact a change in the tissue is not the cause or source of the noise, but rather the design of the dispensing opening is.

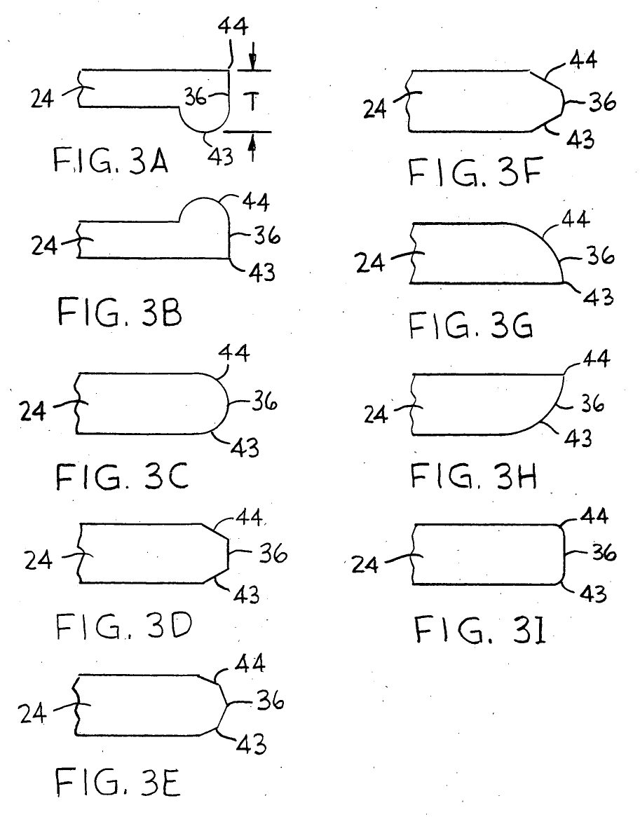

One parameter having an effect on the dispensing force and/or dispensing noise is the thickness of the material forming the perimeter of the dispensing opening or adjacent to the dispensing opening. Through measurement of the dispensing noise and/or dispensing force, as described herein later, the inventors have determined that the thickness of the material, T, forming the perimeter of the dispensing opening, when using a rigid or semi-rigid material, should be at least 0.040 inch (1 mm). Thin plastic dispensing lids having a thickness of about 0.030 inch (0.76 mm) or less and paper or paperboard lids having a thickness of about 0.017 inch (0.43 mm) were found to generate unacceptable noise levels. The thickness of the material, T, forming the perimeter of the dispensing opening should be measured at its thickest part without reducing the measurement by the dimension of any chamfering or radius that may be present as shown in FIG. 3A. In various embodiments of the invention, the thickness of the material, T, forming the perimeter of the dispensing opening can be between about 0.040 inch (1 mm), or about 0.050 inch (1.3 mm), or about 0.060 inch (1.5 mm), or about 0.070 inch (1.8 mm), or about 0.080 inch (2.0 mm), or about 0.090 inch (2.3 mm) to about 0.25 inch (6.4 mm). Thin materials tend to grab and catch the substrate while extremely thick materials tend to be too expensive for disposable dispensers.

Referring now to FIGS. 3A-3I, various cross-sections for the perimeter of the dispensing opening 36 in the dispensing lid are illustrated. As previously discussed, the thickness of the material, T, forming the perimeter of the dispensing opening should be within the above limits. However, if desirable to reduce the per unit part cost, the material forming the dispensing lid located in regions removed from the dispensing opening can be thinner than the material near the dispensing opening as illustrated in FIGS. 3A and 3B.

Another parameter having an effect on the drag force and/or dispensing noise is the presence of a chamfer or radius. The dispensing opening has an interior edge 43 facing the dispenser's interior and the substrate located in the dispenser, and an exterior edge 44. To reduce the dispensing force and/or dispensing noise, at least one of the interior or exterior edges (43, 44) can be chamfered and/or have a radius. For example, in FIG. 3A, the interior edge 43 includes a radius while the exterior edge 44 is a sharp approximately 90 degree corner. In FIGS. 3D, 3E, and 3F, both the interior and exterior edges are chamfered. Desirably, both the interior and exterior edges are chamfered and/or have a radius as shown in FIGS. 3C, 3D, 3E, 3F, and 3I.

The type of substrate, the size of the dispensing opening, and how the substrate is dispensed will control which edge is more critical to chamfer or radius for improved dispensing. For example, if the substrate 26 is pulled considerably off axis during dispensing while being presented uniformly to the dispensing opening 34, it may be more desirable to chamfer the exterior edge 44, especially if the dispensing opening has a sufficiently large area. On the other hand, if the substrate 26 is tightly folded or the dispensing opening 36 does not align well with the folds of the tissue, it may be more desirable to chamfer the interior edge 43, especially if the dispensing opening is small. Often, since it is difficult to predict which edge is more critical, it is simpler to chamfer and/or radius both edges.

Another parameter having an effect on the drag force and/or dispensing noise is the size and shape of the dispensing opening 36. Referring to FIG. 2A, one embodiment for the dispensing opening is illustrated. As seen, the dispensing opening 36 comprises a triangular shaped wedge with two straight sides 46 and a curved side 48 that is shaped similar to a pizza slice. The corners 50, where the sides meet, can have a radius to prevent catching the substrate. The radius can be between about 1 mm to about 10 mm, such as between about 2 mm to about 6 mm. In the illustrated embodiment, the radius was approximately 5 mm. In the illustrated embodiment, the radius of the curved side 48 was approximately 40 mm and the length of the straight sides was approximately 33 mm. The included angle between the two straight sides was approximately 60 degrees and the area of the opening was approximately 840 mm².

One function of a film dispensing window, which is not needed in the current invention, is to prevent multiple dispensing when the substrate is either interfolded or individual sheets are attached by weakened zones. The film dispensing window does this by creating a slight drag on each sheet that acts to separate the leading sheet from the following sheet. The inventors have determined that to replicate this function, the area of the dispensing window can be within specific limits. Specifically, the area of the dispensing opening can be between about 600 mm² to about 2,500 mm², or between about 700 mm² to about 1,500 mm², or between about 750 mm² to about 1,200 mm². When the area is too small, the dispensing force and/or dispensing noise can become unacceptable and the dispenser tends to lift up while dispensing a sheet. If the area is too large, multiple sheet dispensing can become a problem. The area of the dispensing opening is dependent, to some extent, on the sheet size of the substrate, and the substrate's flexibility as it is withdrawn through the dispensing opening.

Another parameter having an effect on the drag force and/or dispensing noise is the orientation of dispensing opening. Referring again to FIG. 2A, the width of the dispensing opening near the dispensing cover's center is greater than the width of the dispensing opening near the cover's perimeter and vertical flange 38. Stated in another way, the dispensing opening's width tapers as you move from the cover's center towards the cover's perimeter.

It is believed that the tapering reduces the incidence of multiple sheet dispensing while still minimizing the dispensing force and/or dispensing noise. This result is believed to occur since, in one embodiment, the tissue stack within the dispenser is folded longitudinally in half forming a generally V-shaped cylinder of tissue as shown in U.S. Pat. No. 3,700,138 issued to Nelson. As a result, more tissue per unit area is present near the center of the dispenser than near the edges since portions of the V near the edges contain no sheet material. By locally increasing the size of the dispenser's opening near the lid's center and then tapering the opening toward the lid's edge, an improved dispensing function can be provided. Furthermore, the folded width of any individual sheet in the V-shaped folded cylinder increases as you move away from the center toward the sidewalls of the cup. In the illustrated dispensing opening, this causes an increase in the interference of the folded sheet near the edges of the dispensing lid as the wider sheet is forced to move through the narrower dispensing opening's width near the edge. In other words, the V of the dispensing opening can be axially aligned with but oppositely oriented with respect to the inverted A of the tissue stack within the dispenser. This can be accomplished by offsetting the dispensing opening to one side of the top panel 34 such that the dispensing opening is not centered in the top panel 34. However, for different folding configurations, the dispensing opening can taper in an opposite manner toward the lid's center or the dispensing opening can be a circular or other shape that does not taper. The dispensing opening can be centered or symmetrically positioned on the top panel 34 in alternative embodiments.

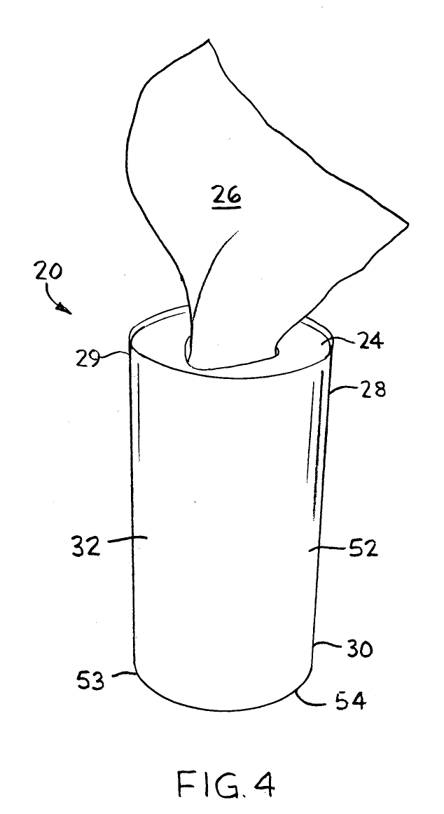

Referring now to FIG. 4, an alternative embodiment for the dispenser 20 is illustrated. The dispenser includes a container comprising a hollow tube 52 and a bottom plug 54 and a dispensing cover 24. Located within the dispenser is a plurality of sheets 26 made from a substrate. The sheets can be individual discrete sheets that may be folded or interfolded for pop-up dispensing. Alternatively, the sheets may be integrally connected to each other by lines of weakness such as perforations. The sheets can be either in a stack or rolled configuration. In one embodiment, the sheets comprised a stack of interfolded facial tissues having approximately 50-60 individual discrete sheets for pop-up dispensing where the next sheet is automatically left partially dispensed upon removal of the preceding sheet. In other embodiments, the dispenser can contain more sheets such as 1,000 sheets or less, 500 sheets or less, 300 sheets or less, and 200 sheets or less.

The hollow tube 52 comprises a top portion 28 having a first open end 29, a bottom portion 30 having a second open end 53, and a sidewall 32. The sidewall 32 can be straight, tapered, or stepped such that the top portion of the tube is larger than the bottom portion. For use in an automobile cup holder, the bottom portion of the dispenser should have a maximum width for sufficient length such that it can be inserted into a cup holder. The maximum width can be less than about 90 mm, such as less than 80 mm. For example, the maximum width can be approximately equal to the 68 mm diameter of a 12 oz. beverage can. In one embodiment, the hollow tube was a straight sided cylinder having a diameter of approximately 77 mm and a height of approximately 160 mm.

The hollow tube, in combination with the dispensing cover and the bottom plug, allows for the dispenser to be readily adapted to automatic loading equipment. Since the hollow tube has two open ends, the sheet material can be readily inserted at high speeds with greater flexibility. For example, a starter sheet can be partially withdrawn from the stack and left protruding from one of the stack's ends. The stack can then be pushed into the container on the side of the stack opposite the protruding starter sheet. Once the sheet material is loaded, a dispensing cover can be placed over the open end adjacent the starter sheet and a bottom plug inserted into the other open end. This provides a convenience since the first sheet is partially exposed and ready to dispense through the dispensing opening without having to remove the dispensing cover to find and start the first sheet. If the container had only one open end, the stack would have to be pushed into the container on the same end as the protruding sheet. This could smash down the starter sheet, defeating its purpose. Also, the hollow tube may be able to be loaded by automatic equipment at higher speeds with greater reliability. When loading the sheet material into a closed end container, the displacement of the air coming out of the container during insertion may cause problems when loading the sheet material since the air will move in a direction opposite to the direction of the sheet material. This can become more of a problem when inserting higher sheet count stacks into small containers such that there is very little clearance between the sheet material and the inside of the container. With the hollow tube, the air can be displaced out one end of the tube as the sheet material is loaded into the other end.

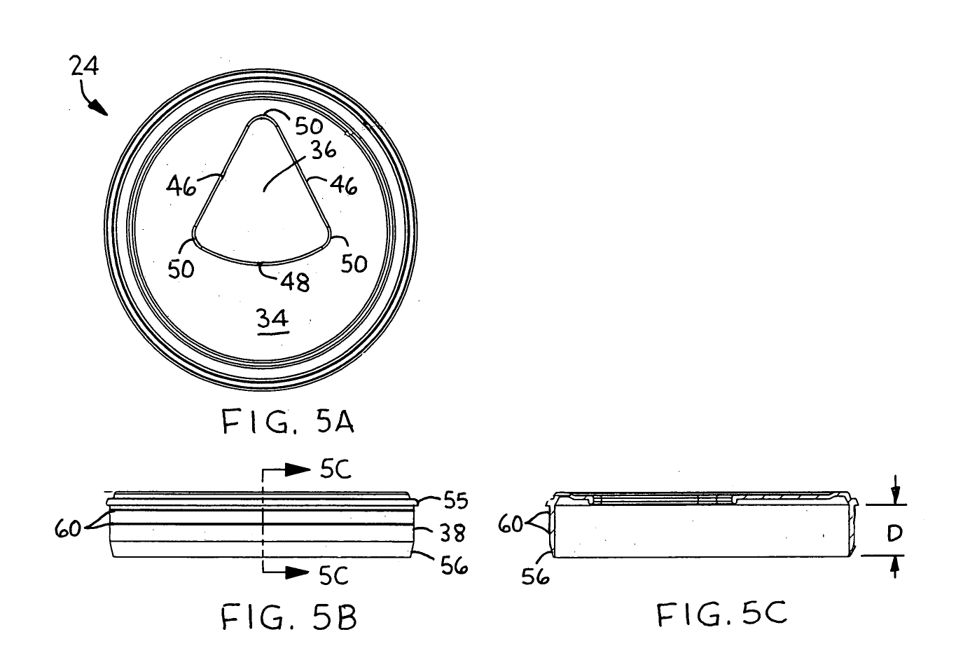

Referring now to FIGS. 5A, 5B, and 5C, the dispensing cover 24 is shown in more detail. In this embodiment, the dispensing cover comprises a dispensing plug that fits into the hollow tube 52. The dispensing plug comprises a top panel 34 having a dispensing opening 36, a vertical flange 38 for insertion into the hollow tube, and a stopping flange 55 to prevent the dispensing plug from being inserted past a predetermined depth.

The vertical flange 38 can have a depth D of between about 45 mm, or about 40 mm, or about 30 mm, or about 20 mm, or about 15 mm, or about 10 mm to about 1 mm since the dispensing cover is intended to be utilized with a container to form a disposable dispenser. The vertical flange 38 may have a taper 56 for ease in starting the dispensing plug into the hollow tube. The diameter of the vertical flange 38 can be sized such that there is a slight interference fit of the vertical flange with the interior of the hollow tube for removably securing the dispensing plug in place. To create more interference, one or more interference flange(s) 60 can project from the surface of the vertical flange 38. Alternatively, the vertical flange can be sized with a slight clearance and the plug secured into the hollow tube with an adhesive, or a glue ring can be used, or a snap fit, or a lock fit can be used to secure the dispensing plug in place. The dispensing plug is made from a rigid or semi-rigid material as opposed to a flexible material such as a thin plastic film.

As discussed previously in connection with the dispensing lid, the same factors for reliable dispensing of the substrate through the dispensing opening in the dispensing plug without the use of a film dispensing window should be controlled to reduce the dispensing drag force (as tested herein later) and/or to reduce the dispensing noise (as tested herein later).

If desired, a second lid without an opening can be placed over the dispensing plug to close the dispensing opening during shipping. Alternatively, a peel strip, surf board, or shrink wrap film can be placed over the dispensing opening and removably attached to the dispenser. In yet another embodiment, a surf board or removable circular disk can be placed over the top panel of the dispensing plug and then a shrink wrap removable film placed over the dispensing plug and part of the top portion of the hollow tube. The shrink wrap and circular disk is then removed and disposed of prior to removing the first sheet from the dispenser. The removable circular disk can be printed with trademark information or other indicia to indicate the contents of the dispenser. This can free the dispenser's exterior surface for use in creating an aesthetic design uncluttered with printed matter unrelated to the aesthetic design.

In another embodiment, the dispensing cover can comprise a top panel having a dispensing opening without using a vertical flange. The dispensing cover can comprise a circular, oval, or other shaped disk that is inserted into the open end of either the hollow tube or the cup. For example, the dispensing cover can comprise a circular disk that is inserted into one open end of the hollow tube that can be made from cardboard. The sidewall of the hollow tube can then be rolled or crimped into place over, around, or adjacent to the circular disk securing the circular disk in position. Alternatively, the disk could snap into a groove or a ring formed on the inside wall of the hollow tube, or the disk could butt up against a flange or a rim inside of the hollow tube.

While the dispensers of the present invention have been shown with circular sidewalls and of a size for insertion into an automobile cup holder, the invention is not limited to these aspects. For example, the dispenser can be made much larger in size for home use or for industrial use for dispensing large substrates such as shop towels. The sidewalls of the dispenser are not limited to circular, oval or other curvilinear shapes, and other shapes such as triangular, rectangular, square, or hexagonal just to name a few are possible. Other substrates besides facial tissue can be dispensed from the dispenser. The choice of the type of dispensing cover is not limited to those illustrated with each embodiment. For example, the cup could be fitted with a dispensing plug and the hollow tube could be fitted with a dispensing lid. The vertical flange can be eliminated and other methods used to attach the dispensing cover to the container employed such as fasteners, adhesives, a snap fit, a threaded connection, or a rolled crimped end. The invention is not limited to containers such as the cup or the hollow tube with a bottom plug. Other suitable containers can be used such as a formed bottom tube, thermoformed containers of any size or shape, or containers assembled from flat carton blanks are suitable just to name a few.

### EXAMPLES

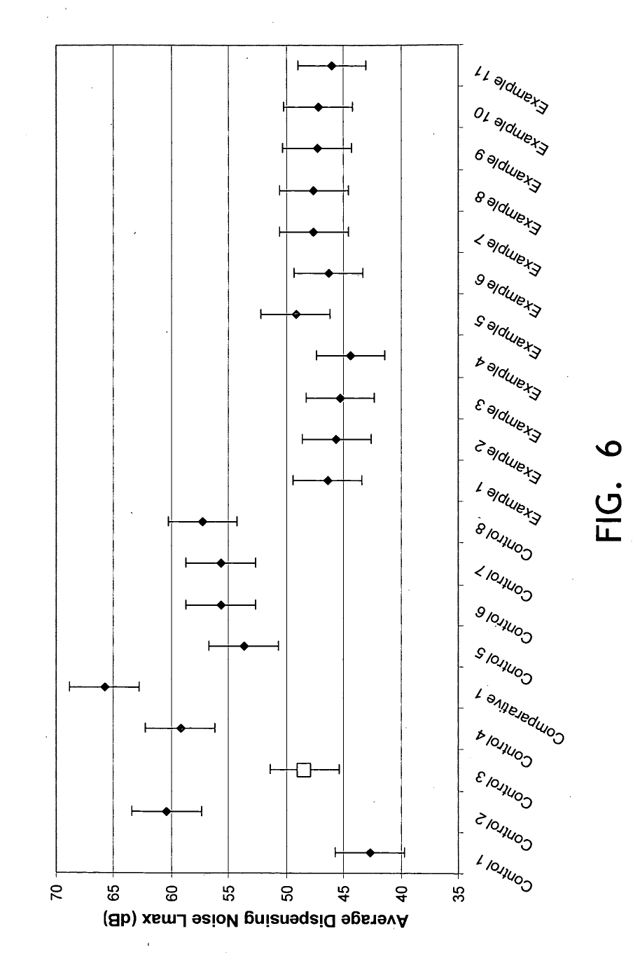

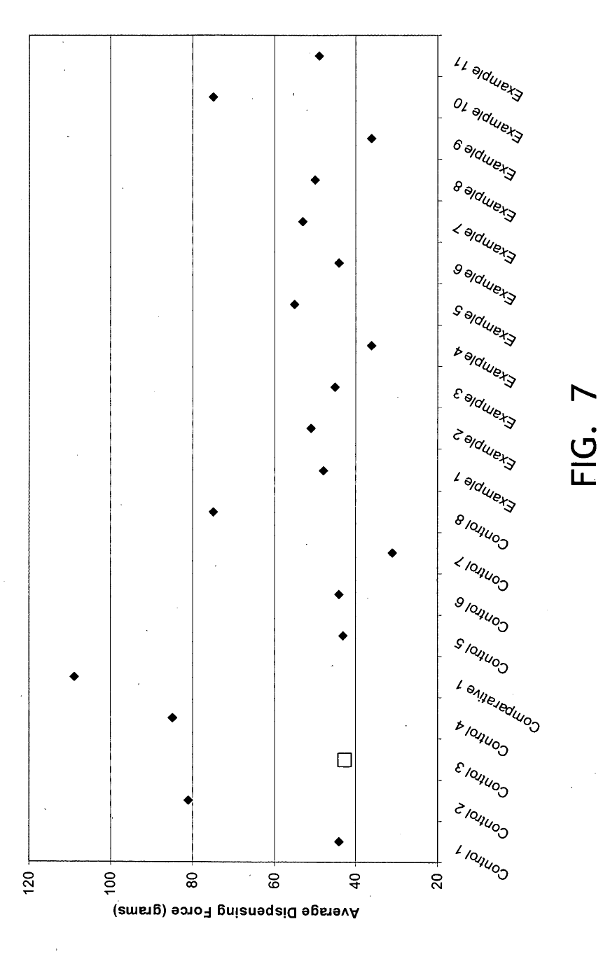

The invention can be better understood with regard to various dispensers that were tested for dispensing force and dispensing noise. The results of the testing is tabulated in Table 1 and plotted in FIGS. 6 and 7.

Control 1

Control 1 was the cup container illustrated in FIG. 1 without the dispensing lid attached to the open end of the cup. Thus, the dispensing noise and dispensing force for this example is expected to be the lowest possible since a restrictive dispensing opening through which the tissue is withdrawn is not present. Control 1 had an Lmax level of 43 dB and an average dispensing force of 44 grams.

Control 2

Control 2 was the approximately 77 mm diameter hollow tube container illustrated in FIG. 2 that had a 2 inch (50.8 mm) diameter circular dispensing opening in the top panel, which was constructed of thin paperboard that was 0.017 inch (0.43 mm) thick. Control 2 had an Lmax level of 60 dB and an average dispensing force of 81 grams.

Control 3

Control 3 was the same as Control 2, except that the dispensing opening also included a film dispensing window having a dispensing slit shaped like a plus sign (+). Control 3 had an Lmax level of 48 dB and an average dispensing force of 42 grams. As seen, the dispensing noise and force was comparable to Control 1, which had no dispensing cover.

Control 4

Control 4 was the cup container with the dispensing opening illustrated in FIG. 2, only made from a thin paperboard material that was 0.017 inch (0.43 mm) thick. Control 4 had an Lmax level of 59 dB and an average dispensing force of 85 grams.

Control 5

Control 5 was the cup container with a dispensing cover made from a thin 0.025 inch (0.64 mm) thick plastic material that had a 1.625 inch (41.3 mm) circular diameter dispensing opening. Control 5 had an Lmax level of 54 dB and an average dispensing force of 43 grams.

Control 6

Control 6 was the cup container with a dispensing cover made from a thin 0.025 inch (0.64 mm) thick plastic material that had a 1.75 inch (44.5 mm) circular diameter dispensing opening. Control 6 had an Lmax level of 56 dB and an average dispensing force of 44 grams.

Control 7

Control 7 was the cup container with a dispensing cover made from a thin 0.025 inch (0.64 mm) thick plastic material that had a 2 inch (50.8 mm) circular diameter dispensing opening. Control 7 had an Lmax level of 56 dB and an average dispensing force of 31 grams.

Control 8

Control 8 was the cup container with a dispensing opening illustrated in FIG. 2 made from a thin 0.025 inch (0.64 mm) thick plastic material that had a dispensing area of approximately 834 mm². Control 8 had an Lmax level of 57 dB and an average dispensing force of 75 grams.

### Comparative Example 1

Comparative Example 1 was a commercially available TissueKups facial tissue dispenser available from the TissueKups Company having a web site located at http://www.tissuekups.com/home.html. The dispenser had a domed dispensing cap with a 1 inch (25.4 mm) circular diameter dispensing orifice in a thin plastic material that measured 0.020 inch (0.51 mm) thick. The dispensing opening did not have a radius or chamfer on either the interior or exterior edge of the dispensing opening. When dispensed, the tissue sheet tended to snag and grab on the dispensing orifice creating an unacceptable dispensing noise and a large dispensing force. The tissue from this dispenser did not dispense smoothly or uniformly. Furthermore, the dispenser tended to lift off the surface when attempting to dispense the tissue. Comparative Example 1 had an Lmax level of 66 dB and an average dispensing force of 109 grams.

### Example 1

Example 1 was the cup container with a dispensing cover made from a 0.056 inch thick (1.4 mm) paperboard material that had a 1.50 inch (38.1 mm) circular diameter dispensing opening. Example 1 had an Lmax level of 46 dB and an average dispensing force of 48 grams.

### Example 2

Example 2 was the cup container with a dispensing cover made from a 0.056 inch thick (1.4 mm) paperboard material that had a 1.625 inch (41.3 mm) circular diameter dispensing opening. Example 2 had an Lmax level of 46 dB and an average dispensing force of 51 grams.

### Example 3

Example 3 was the cup container with a dispensing cover made from a 0.056 inch thick (1.4 mm) paperboard material that had a 1.75 inch (44.5 mm) circular diameter dispensing opening. Example 3 had an Lmax level of 45 dB and an average dispensing force of 45 grams.

### Example 4

Example 4 was the cup container with a dispensing cover made from a 0.056 inch thick (1.4 mm) paperboard material that had a 2 inch (50.8 mm) circular diameter dispensing opening. Example 4 had an Lmax level of 44 dB and an average dispensing force of 36 grams.

### Example 5

Example 5 was the cup container with the dispensing lid illustrated in FIG. 2 that was made from a medium thickness plastic material that was 0.070 inch (1.8 mm) thick surrounding the dispensing opening. Both the interior edge and the exterior edge had a radius. The average dispensing force test for Example 5 was repeated four times, and the four test average of the average dispensing force was determined to be 55 grams. The standard deviation of the individual results of the four tests was 9.4 grams. The repeated testing of Example 5 was done to determine the variability in the average dispensing force test. Example 5 had an average Lmax level of 49 dB and a four test average dispensing force of 55 grams.

### Example 6

Example 6 was the cup container with a dispensing cover made from a 0.125 inch (3.2 mm) thick plastic material that had a 1.50 inch (38.1 mm) circular diameter dispensing opening. Both the interior and exterior edges of the dispensing opening had a radius. Example 6 had an Lmax level of 46 dB and an average dispensing force of 44 grams.

### Example 7

Was the same as Example 6, only the dispensing opening did not have a radius on either the interior edge or the exterior edge. Example 7 had an Lmax level of 48 dB and an average dispensing force of 53 grams.

### Example 8

Example 8 was the cup container with a dispensing cover made from a 0.125 inch (3.2 mm) thick plastic material that had a 1.625 inch (41.3 mm) circular diameter dispensing opening. Example 8 had an Lmax level of 48 dB and an average dispensing force of 50 grams.

### Example 9

Example 9 was the cup container with a dispensing cover made from a 0.125 inch (3.2 mm) thick plastic material that had a 1.75 inch (44.5 mm) circular diameter dispensing opening. Example 9 had an Lmax level of 47 dB and an average dispensing force of 36 grams.

### Example 10

Example 10 was the cup container with the dispensing lid illustrated in FIG. 2 that was made from a thick plastic material that was 0.125 inch (3.2 mm) thick. The interior edge and the exterior edge did not have a radius. Example 10 had an Lmax level of 47 dB and an average dispensing force of 75 grams.

### Example 11

Example 11 was the same as Example 10 except the interior edge and the exterior edge had a radius. Example 11 had an Lmax level of 46 dB and an average dispensing force of 49 grams.

TABLE 1

| | | | | | | Avg. | Avg. |
|---|---|---|---|---|---|---|---|
| | | | Thickness | Area | | Force | Lmax |
| Sample | Shape | Material | (mm) | (mm²) | Radius | (g) | (dB) |
| Control 1 | N/A | N/A | N/A | N/A | N/A | 44 | 43 |
| Control 2 | 2″ Circle | Thin Paper | 0.43 | 2027 | None | 81 | 60 |
| Control 3 | 2″ Circle | Thin Paper | 0.43 | 2027 | None | 42 | 48 |
| Control 4 | Triangle | Thin Paper | 0.43 | 838 | None | 85 | 59 |
| Comparative 1 | 1″ Circle | Thin Plastic | 0.51 | 507 | None | 109 | 66 |
| Control 5 | 1⅝″ Circle | Thin Plastic | 0.64 | 1338 | None | 43 | 54 |
| Control 6 | 1¾″ Circle | Thin Plastic | 0.64 | 1552 | None | 44 | 56 |
| Control 7 | 2″ Circle | Thin Plastic | 0.64 | 2027 | None | 31 | 56 |
| Control 8 | Triangle | Thin Plastic | 0.64 | 838 | None | 75 | 57 |
| Example 1 | 1½″ Circle | Thick Paper | 1.42 | 1140 | None | 48 | 46 |
| Example 2 | 1⅝″ Circle | Thick Paper | 1.42 | 1338 | None | 51 | 46 |
| Example 3 | 1¾″ Circle | Thick Paper | 1.42 | 1552 | None | 45 | 45 |
| Example 4 | 2″ Circle | Thick Paper | 1.42 | 2027 | None | 36 | 44 |
| Example 5 | Triangle | Medium Plastic | 1.78 | 838 | Yes | 55 | 49 |
| Example 6 | 1½″ Circle | Thick Plastic | 3.18 | 1140 | Yes | 44 | 46 |
| Example 7 | 1½″ Circle | Thick Plastic | 3.18 | 1140 | None | 53 | 48 |
| Example 8 | 1⅝″ Circle | Thick Plastic | 3.18 | 1338 | None | 50 | 48 |
| Example 9 | 1¾″ Circle | Thick Plastic | 3.18 | 1552 | None | 36 | 47 |
| Example 10 | Triangle | Thick Plastic | 3.18 | 838 | None | 75 | 47 |
| Example 11 | Triangle | Thick Plastic | 3.18 | 838 | Yes | 49 | 46 |

Referring now to Table 1 and FIG. 6, an important result can be observed for the dispensing cover of the present invention. In particular, it can be observed that as the material forming the perimeter of the dispensing opening becomes too thin, the dispensing noise is increased appreciably from Control 1, the tissue dispenser having an open top and no dispensing opening. Similarly, the dispensing noise is increased appreciably from Control 3, the tissue dispenser having a poly film dispensing window. In general, for a consumer preferred dispenser, the dispenser should have a dispensing noise level, Lmax, of less than about 50 dB, such as between about 40 dB to about 50 dB, so that the noise generated when dispensing the tissue through the dispensing opening is approximately the same as the noise generated dispensing the facial tissue through a film dispensing window (Control 3).

Referring now to Table 1 and FIG. 7, another important result can be observed for the dispensing cover of the present invention. In particular, it can be observed that the area of the dispensing opening has a direct impact on the dispensing force. When the area is too small, an unacceptably large dispensing force is generated that could tear the facial tissue. On the other hand, if the area is too large, multiple sheet dispensing can become a problem. Similarly, sharp interior or exterior edges can cause unacceptable dispensing forces, especially when combined with small dispensing openings. For example, comparing Example 10 and 11, the only difference was the presence of a radius on the dispensing opening. Example 11 had a much lower average dispensing force than Example 10. For a consumer preferred dispenser, the dispenser should have a minimum level of dispensing force while not having multiple sheet dispensing problems. Desirably, the average dispensing force should be comparable to Control 1 having no dispensing cover or control 3 having a film dispensing window. In general, for a consumer preferred dispenser, the dispenser should have an average dispensing force between about 70 grams, about 60 grams, about 50 grams, about 40 grams to about 20 grams.

Without wishing to be bound by theory, it is believed that the design of the dispensing opening for optimum noise levels and/or dispensing force can be more difficult for a dry substrate, such as facial tissue, as opposed to a wet substrate such as wet wipes. This result is believed to occur since the water and the surfactants present in the wet wipes can act as a lubricant reducing the drag force and consequently the dispensing noise when dispensing the wet substrate through a restrictive orifice. The soapy film left on the dispensing opening can make it easier to withdraw the wet substrate and helps to smoothly glide the wet substrate through the dispensing opening. Dry substrates do not have the advantage of this liquid to assist with dispensing.

Furthermore, dry substrates may not be as flexible or as limp as wet substrates, again owing to the lack of liquid on the sheet. Think of a dry sheet of paper and then the same sheet of paper that is fully saturated with water. The dryness of the substrate can make it harder to withdraw the dry substrate through a restrictive orifice, especially when the film dispensing window is not used, and a rigid or semi-rigid material forms the perimeter of the dispensing opening. This result is believed to occur since the traditional film dispensing window with a slit can bend and distort along with the dry substrate as it is pulled through the window, promoting a lower dispensing force and/or noise. However, when a rigid or semi-rigid material forms the dispensing opening, the dry substrate must conform to the dispensing opening without the benefit of the film window also flexing and moving.

### Test Methods

Average Lmax Dispensing Noise Test

The objective of the test is to measure the average peak dispensing noise as a sheet of facial tissue is dispensed from a dispenser. It is believed that a lower noise level correlates with an improved dispensing function and a more favorable impression during usage by those using the dispenser.

Definitions:

Decibel: Logarithmic unit of sound pressure or energy. In this test, decibel will always refer to sound pressure.

Sound Pressure Level (SPL): The pressure of a sound wave in decibels.

Maximum Sound Level (Lmax): This is the maximum time and frequency weighted sound level calculated using time and frequency weighting parameters. Lmax is calculated using “A” frequency-weighting and “S” time-weighting. See IEC Standard 61672.

“A” Weighting—Method of sound level attenuation used by sound level meters to more closely mimic the human ear. The A-weighting filters out significantly more bass, eliminating inaudible low frequencies.

Equipment:

1. Test Chamber having dimensions of 24 inches wide by 18 inches deep by 36 inches high with 2 inch thick acoustical foam located on the interior walls and front door.
2. Quest 1900 Type 1 sound level meter available from Quest Technologies, Inc. having an office in Oconomowoc, Wis.
3. Quest OB-100 octave band filter available from Quest Technologies, Inc. having an office in Oconomowoc, Wis.
4. Quest Sound Calibrator (QC-10 or QC-20) available from Quest Technologies, Inc. having an office in Oconomowoc, Wis.
5. Facial tissue sold as KLEENEX JUNIORS available from Kimberly-Clark Corporation having an office in Neenah, Wis. The facial tissue is a 65 sheet count, two ply sheet with each sheet in the stack measuring approximately 5.7 inch by 8.4 inch. Each sheet is V folded in half and then interfolded with the adjacent sheet for pop-up dispensing. The facial tissue has an approximate strength of 650 grams geometric mean tensile.

Test Preparation:
1. Quest 1900 Sound Meter: Attach the band filter to the sound meter per instruction manual. Calibrate the sound meter using the sound calibrator. Refer to the instruction manuals for operation. Use the settings below for measurement:
   Range: 20-80 dB
   Weighting: A
   Time Constant: Fast
   Threshold: Off
   Exchange Rate: 3 dB
   Peak Weighting: C
2. Insert the microphone of the sound meter into a snug fitting opening in the side of the test chamber such that the microphone is located approximately 14.5 inches from the bottom and 6.75 inches from the front of the chamber.

Sample Preparation:
1. Open the box of facial tissues and remove the clip of tissues.
2. Remove the first 5 sheets and dispose of them.
3. Without pulling the next sheet, displace the top sheet upward by ½ the length of the facial tissue.
4. Curve the remaining sheets in the clip around the displaced sheet.
5. Insert the curved clip into the test dispenser with the displaced sheet extending from the open end of the dispenser.
6. Place the dispensing cover (lid or plug) onto the dispenser.
   Procedure:
1. Open test chamber door. The door should remain in this position for entire test. Make sure that room surrounding instrument is as free from noise as possible. The background noise should not exceed approximately 20-25 dB as measured using the settings in the next step.
2. Measure the background noise level prior to testing or during changes to conditions.
   Set the octave filter to Manual.
   Adjust the filter to 2K
   Acquire data for 20 seconds
   Turn off octave filter.
3. Activate the sound level meter octave filter. Adjust to 2K.
4. Start acquisition of data. Take note as to what set of data is currently recording.
5. Hold the top of the dispenser approximately 7 inches from the tip of the microphone. If necessary, the dispenser can be angled slightly toward the front of the chamber to ensure the tissues are withdrawn axially.
6. The sound level meter will display a new reading every second. When a new reading is displayed, pull a sheet of facial tissue from the dispenser.
7. Wait 5 seconds, and repeat step 6. Repeat until the dispenser is empty while maintaining a consistent dispensing method. The tissue should be dispensed axially from the dispensing opening at a speed that is representative of a normal facial tissue dispensing rate. An extremely slow or extremely fast speed should be avoided and the sheet should be dispensed at a speed of approximately 20-25 inches per second (50.8-63.5 cm/s).
8. Turn off the data acquisition.
9. Turn off the octave filter.
10. Repeat steps 3-9 for remaining samples.
   Analysis:

Sound is typically measured by instruments in decibels. Decibels are a base-10 log conversion of actual pressure fields produced by sound. The following equation is used to convert pressure to decibels [1]:

$$\begin{matrix}SPL ( dB ) = 10 log {( \frac{{P}_{e}}{{P}_{0}} )}^{2} \\ = 20 log ( \frac{{P}_{e}}{{P}_{0}} )\end{matrix}$$

where P₀ is the reference pressure level of 20 μPa and Pₑ is the effective pressure of the sound wave measured. NOTE: Due to the log-10 conversion of pressure, simple determination of averages, standard deviations, and confidence intervals may be inaccurate. Therefore, all statistical analysis is completed in the pressure regime, and then converted to decibels as appropriate.

For each dispenser tested, determine the Lmax value for each sheet dispensed by importing the recorded data from the sound meter into a spreadsheet program such as EXCEL. Once the peak sound level, Lmax, is determined for each sheet dispensed, average the sixty (60) individual Lmax values for each sheet to determine the average Lmax sound level.

Most noise standards recognize a 3 dB exchange rate. The exchange rate, based on the decibel scale, signifies a doubling of the sound energy dose. Therefore, average Lmax values with a difference greater than the 3 dB exchange rate are more likely significant. In FIG. 6, the average Lmax levels are shown with ±3 dB bars to help identify significant differences.

Average Dispensing Force Test

The objective of the test is to measure the average dispensing force as a stack of facial tissue sheets is dispensed from the first sheet to the last sheet. In general, the first sheets dispensed will have a higher force than the last sheets dispensed since the sheets are more tightly packed when the dispenser is full.

Apparatus & Materials:

1. Sintech tensile tester or similar tensile frame with a speed capability of at least 80 inches per minute.
2. Clamping mechanism to hold the dispenser securely and centered in the lower fixture of tensile frame without obstructing the dispensing opening. The clamping mechanism should prevent the dispenser from moving in any plane when the tissues are dispensed.
3. Upper clamping grip to securely hold the exposed tissue sheet without slippage. An approximately 4 inch wide clamp can be used.
4. Facial tissue sold as KLEENEX JUNIORS available from Kimberly-Clark Corporation having an office in Neenah, Wis. The facial tissue is a 65 sheet count, two-ply sheet with each sheet in the stack measuring approximately 5.7 inch by 8.4 inch. Each sheet is V folded in half and then interfolded with the adjacent sheet for pop-up dispensing. The facial tissue has an approximate strength of 650 grams geometric mean tensile.
   Tensile Tester Parameters:
1. Speed: Set at 80 inches per minute.
2. Gage Length: Set the gage length such that the space between the lowest contact point of the upper grip face and the dispensing cover of the dispenser is 1.5 inches.
3. Break Point: Set the break point at 95 percent drop in load value from the peak load. Otherwise set the machine to stop after a fixed amount of travel that ensures the tissue is completely removed from the dispenser.
4. The Peak Load in grams is recorded between 0.4 inch (10.2 mm) of extension and the break point in order to ensure that the initial inertia in accelerating the crosshead does not exceed the peak load required to remove the tissue sheet from the dispenser.
   Sample Preparation:
1. Open the box of facial tissues.
2. Remove the first 5 sheets.
3. Without pulling the next sheet, displace the top sheet upward by ½ the width of the sheet.
4. Curve the remaining tissue stack around the displaced sheet.
5. Insert the curved stack into the dispenser. Make sure that the displaced sheet can be removed from the top of the dispenser.
6. Replace the dispensing cover with the displaced sheet extending through the dispensing opening.
   Test Setup:
1. Secure the dispenser into the clamping mechanism and secure the clamping mechanism to the lower fixture of the tensile frame.
2. Attach the upper grip to the upper fixture of the tensile frame.
3. Lower the upper fixture of the tensile frame until the lowest contacting surface of the grip is 1.5 inches from the upper surface of the dispensing cover.
4. With the grip faces separated, position the tissue sheet protruding from the dispenser between the separated faces. Do not manually dispense the tissue from the dispenser during this process unless necessary to provide enough tissue protrusion to reach the grip. If manual dispensing of the tissue is necessary, note that for the data analysis. Remove any slack tissue between the upper grip and the dispensing cover before closing the grip so the exposed tissue is taut without manually pulling the tissue from the dispenser. Note that following this procedure may result in more than one tissue being clamped into the grip. In this case, make a note of the phenomenon as it will reduce the total number of pulls used to calculate the average.
   Procedure:
1. Set up the test frame with the above test parameters and record the load cell data at a sufficient sampling rate to ensure the maximum dispensing force is accurately recorded. Calibrate the test frame and load cell following the manufacture's procedures prior to testing.
2. For each tissue dispensed, the grip in the upper tensile frame fixture should be returned to the original starting position.
3. Any multiple sheet dispensing or tissue follows where more than one sheet is dispensed should be recorded when the follow occurred. For example, if the 3^{rd} tissue dispensed had a tissue follow then record “pull #3 tissue follow”.
   Results:

Record the peak dispensing force in grams for each sheet removed from the dispenser until all sheets are dispensed. Determine the average dispensing force from the first sheet to the last sheet by dividing the sum of the dispensing force for all pulls by the number of pulls. If multiple sheet dispensing results in pulling two or more sheets out of the dispenser, then the denominator for determining the average is reduced accordingly I.E. if two or more sheets come out in one pull, instead of dividing the sum by 60, it is divided by 59. Record the average dispensing force to the nearest gram.

Other modifications and variations to the present invention may be practiced by those of ordinary skill in the art, without departing from the spirit and scope of the present invention, which is more particularly set forth in the appended claims. It is understood that aspects of the various embodiments may be interchanged in whole or part. All cited references, patents, or patent applications in the above application for letters patent are herein incorporated by reference in a consistent manner. In the event of inconsistencies or contradictions between the incorporated references and this application, the information present in this application shall prevail. The preceding description, given by way of example in order to enable one of ordinary skill in the art to practice the claimed invention, is not to be construed as limiting the scope of the invention, which is defined by the claims and all equivalents thereto.

1. A product comprising:
a container and a dispensing cover having a top panel and a dispensing opening located in the top panel;
the dispensing cover attached to the container to form a dispenser;
a dry substrate located within the dispenser; and
wherein a thickness of the top panel forming a perimeter of the dispensing opening is between about 0.040 inch (1 mm) to about 0.25 inch (6.4 mm).

2. The product of claim 1 wherein the container is circular or oval.

3. The product of claim 1 wherein
the container comprises a bottom, a sidewall, and an open end; and
the dispensing cover comprises a dispensing lid that is attached over the open end to form the dispenser.

4. The product of claim 3 wherein the container comprises a cup having a circular bottom having a diameter less than about 90 mm.

5. The product of claim 1 wherein
the container comprises a hollow tube having a first and a second open end, and a bottom plug is inserted into the second open end forming the container; and
the dispensing cover comprises a dispensing plug that is inserted into the first open end to form the dispenser.

6. The product of claim 5 wherein the bottom plug is circular and has a diameter less than about 90 mm.

7. The product of claim 3 or 5 wherein the dry substrate comprises tissue.

8. The product of claim 1, 3, or 5 wherein the dispenser has an average dispensing noise level Lmax of about 50 dB or less when the dry substrate is dispensed.

9. The product of claim 1, 3, or 5 wherein the dispenser has an average dispensing force of about 70 grams or less when the dry substrate is dispensed.

10. The product of claim 1, 3, or 5 wherein the dispenser has an average dispensing noise level Lmax of about 50 dB or less and an average dispensing force of about 70 grams or less when the dry substrate is dispensed.

11. The product of claim 1 wherein the dispensing opening comprises an interior edge and an exterior edge and at least one of the interior or exterior edges is chamfered or radiused.

12. The product of claim 11 wherein both the interior and exterior edges are chamfered or radiused.

13. The product of claim 1 wherein the thickness forming the perimeter of the dispensing opening is between about 0.060 inch to about 0.25 inch (6.4 mm).

14. The product of claim 1 wherein the dispensing cover comprises a vertical flange has a recess and a projection for attaching the dispensing cover to the container.

15. The product of claim 1 wherein the dispensing cover comprises a vertical flange and a stopping flange for inserting the dispensing cover into the container.

16. The product of claim 1 wherein the dispensing opening comprises a triangular shaped wedge having two straight sides, a curved side, and three corners.

17. The product of claim 16 wherein the corners are radiused.

18. The product of claim 1 wherein the dispensing opening has a width and the width of the dispensing opening near the dispensing cover's center is greater than the width of the dispensing opening near the dispensing cover's perimeter.

19. The product of claim 1 wherein the dispensing opening has an area and the area of the dispensing opening is between about 600 mm² to about 2,500 mm².

20. A product comprising:
a dispensing cover having a top panel and a vertical flange extending from the top panel;
the vertical flange has a depth that is less than about 45 mm;
a dispensing opening located in the top panel; and
wherein a thickness of the top panel forming a perimeter of the dispensing opening is between about 0.040 inch (1 mm) to about 0.25 inch (6.4 mm) and the area of the dispensing opening is between about 600 mm² to about 2,500 mm².

21. The product of claim 20 wherein the vertical flange is circular or oval.

22. The product of claim 20 comprising:
a container having a bottom, a sidewall, and an open end; and
the dispensing cover comprises a dispensing lid that is attached over the open end to form a dispenser.

23. The product of claim 22 wherein the container comprises a cup.

24. The product of claim 20 comprising:
a hollow tube having a first open end and a second open end;
a bottom plug inserted into the second open end to form a container;
and the dispensing cover comprises a dispensing plug that is inserted into the first open end to form a dispenser.
